(19) United States
(12) Patent Application Publication
(10) Pub. No.: US 2017/0177823 A1
(43) Pub. Date: Jun. 22, 2017

(54) PREDICTION OF READMISSION RISK

(71) Applicant: CERNER INNOVATION, INC., Kansas City, KS (US)

(72) Inventors: COLE ANTHONY ERDMANN, KANSAS CITY, MO (US); JING LI, RENSSELAER, NY (US)

(21) Appl. No.: 14/974,552

(22) Filed: Dec. 18, 2015

(51) Int. Cl. G06F 19/00

(52) U.S. Cl. CPC G06F 19/3431

(57) ABSTRACT

Methods, systems, and computer-storage media are provided for determining a patient's risk for readmission to an acute care facility after being discharged to an inpatient rehabilitation facility. For instance, upon admission to the inpatient rehabilitation facility, a sampling protocol is initiated where a computer store is accessed on a predetermined schedule to sample a pre-selected set of healthcare data elements for the patient. Logistic regression is executed on the pre-selected set to generate a readmission risk score for the patient. The patient's electronic health record is modified to reflect the generated readmission risk score.

### BACKGROUND

Reducing the risk of a patient being readmitted to an acute care facility (ACF) after being discharged to an inpatient rehabilitation facility (IRF) is an important concern for the ACF as well as the IRF, especially unplanned readmissions which may represent up to 90% of all readmissions. For instance, the ACF may receive a lower level of reimbursement from a payer when the patient is readmitted to the ACF. As well, readmission rates are monitored by the Centers for Medicare and Medicaid Services (CMS) and may impact quality of care metrics for the ACF and for the IRF. High rates of readmission may also decrease the number of patient referrals to the IRF. And importantly, high rates of readmission may negatively impact the patient's care experience.

There have been previous attempts to determine the risk for readmission to an ACF. For example, some methodologies that attempt to quantify a patient's risk of readmission use patient healthcare data obtained prior to the patient being admitted to the IRF (i.e., patient data from the ACF) and are principally based on the patient's primary diagnosis. These types of methodologies fail to take into account important healthcare data obtained while the patient is being cared for at the IRF. Other methodologies attempt to find correlations between patient orders initiated while the patient is being cared for at the IRF and potential risk for readmission to an ACF. For instance, an order for oxygen may initiate a recommendation to monitor the patient more closely. Still other approaches rely on human clinical acumen in determining whether a patient is at risk for readmission. However, it has been found that clinicians often lack the ability to accurately identify patients at risk for readmission. Moreover, the approaches outlined above are not driven by quantitative data, and lack of a data-driven approach to quantifying a risk for readmission may inhibit the healthcare industry from realizing increases in efficiency as evidenced by, for example, reductions in readmission rates.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

At a high level, the present invention identifies patients being cared for at an inpatient rehabilitation facility (IRF) who are at risk for readmission to an acute care facility (ACF). The identification process occurs at an early point during the patient's stay at the IRF (e.g., within the first four days of the patient's stay at the IRF), which allows interventions to be timely initiated in order to reduce the patient's risk for readmission. The result is an overall decrease in healthcare spend for the patient as well as an improved care experience for the patient.

Aspects herein describe computer-storage media, computerized methods, and computing systems that determine a readmission risk score for a patient using a pre-selected set of healthcare data elements stored in a computer store. Upon a patient's admission to an IRF, a sampling protocol is initiated where a computer server automatically accesses a computer store storing healthcare data elements for the patient according to a predetermined schedule. A pre-selected set of the healthcare data elements is sampled and processed using logistic regression analysis to generate a readmission risk score for the patient, where the readmission risk score represents a probability that the patient will be readmitted to an ACF. The readmission risk score is represented by a visually perceptible element, and the server serves the visually perceptible element to a browser window that displays the visually perceptible element to an end-user such as a clinician.

As well, aspects herein are directed to using the readmission risk score to automatically assign the patient into one of a high probability of readmission category, a moderate probability of readmission category, or a low probability of readmission category. This assignment may be automatically updated in response to contextual information received by the server at different points during the patient's stay at the IRF. For example, some information such as the patient's Risk Impairment Category (RIC), Case Mixed Group (CMG) indication, and co-morbidity listing may not be available until after the patient has been admitted to the IRF for a certain period of time (e.g., after approximately four days). Once this information is available, the computer server described herein may use the information to update the patient's readmission score and/or risk stratification. In an additional aspect, the computer server may automatically generate one or more recommended clinical interventions for the patient based on the patient's readmission risk score and/or risk stratification.

The server, as described herein, is further configured to access an electronic health record (EHR) of the patient and modify the EHR to reflect the readmission risk score, the risk category to which the patient is assigned, any modifications to the risk category, and/or any recommended clinical interventions. Subsequent computer users accessing the patient's EHR can quickly retrieve this information and use the information to guide patient care decisions such that readmission risk for the patient is reduced. Moreover, by modifying the patient's EHR to reflect the readmission risk score, the assigned risk category, and/or recommended clinical interventions, improved computing system efficiencies are realized. For example, less computer “clicks” or entries to the EHR are needed by the computer user to review patient information in order to make a manual determination of whether the patient may be at risk for readmission, and/or to make manual determinations of appropriate clinical interventions. Fewer “clicks” or entries reduces memory utilization, CPU cycles, number of operations that need to be performed by the computer, and power consumption by the computer.

### BRIEF DESCRIPTION OF THE DRAWINGS

Embodiments are described in detail below with reference to the attached drawings figures, wherein:

FIG. 1 is a block diagram of an exemplary computing environment suitable to implement embodiments of the present invention;

FIG. 2 is an exemplary system architecture suitable to implement embodiments of the present invention; and

FIGS. 3-4 are flow diagrams depicting embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-readable media for a system and method for computer-based healthcare information users to monitor a patient's risk for readmission to an acute care facility while being cared for at an inpatient rehabilitation facility

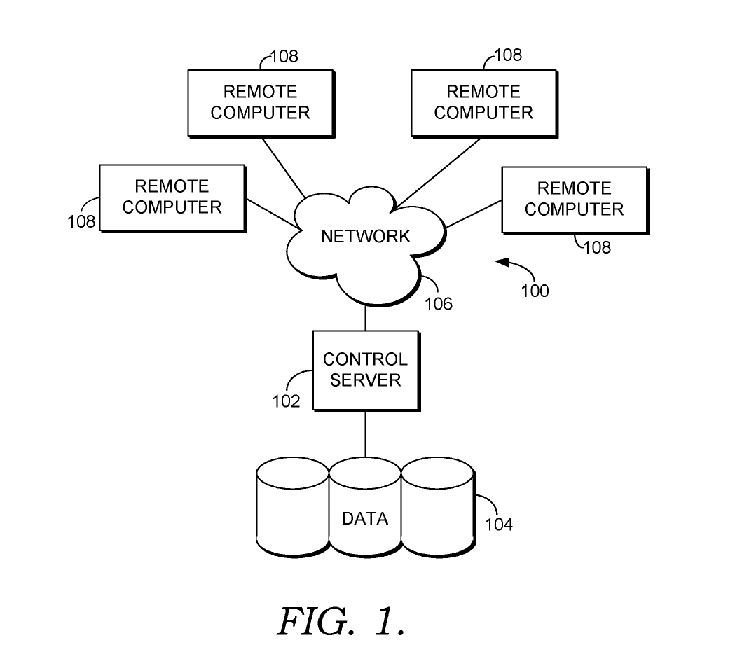

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention is a special computing system that can leverage well-known computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a microphone (e.g., voice inputs), a touch screen, a pointing device (commonly referred to as a mouse), a trackball, or a touch pad. Other input devices comprise satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

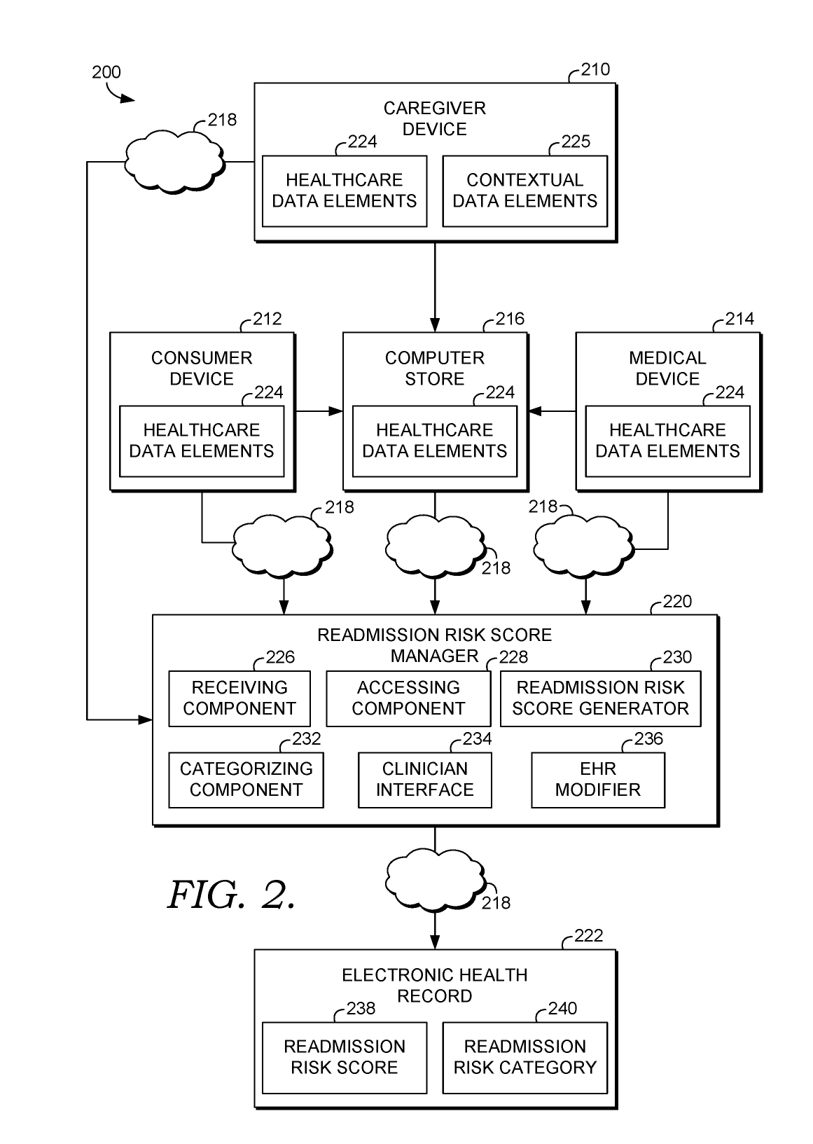

In an embodiment exhibited by FIG. 2, the processing duties are split among several computing systems such as the caregiver device 210, the consumer device 212, the medical device 214, and the readmission risk score manager 220. The computer store 216 and the electronic health record (EHR) 222 may be implemented through a database server. The network 218, such as the internet or other public or private network, serves as a communications link to consumer devices 212, the computer store 216, medical devices 214, caregiver devices 210, the readmission risk score manager 220, and the patient's EHR 222. The tasks performed by the processor utilize a variety of computer technologies. In one embodiment, the technologies can be divided into three tiers, web server, application server and database server. Each tier is comprised of a number of system layers as described below.

In aspects, the computer store 216 stores healthcare data elements 224 for patients that are currently admitted to, or have previously been admitted to, a particular IRF. The healthcare data elements 224 may be supplied by consumer devices 212 used by the patient while being admitted to the IRF, medical devices 214 that monitor the patient after being admitted to the IRF, and/or caregiver devices 210 used by clinicians caring for the patient during the patient's stay at the IRF. Consumer devices 212 may comprise, for instance, a mobile phone associated with the patient. Medical devices 214 may comprise patient beds, electronic security devices, vital-sign detecting devices, lab devices, medication administration devices, and/or any devices that generate medical information for the patient. The medical devices 214 may generate various healthcare data elements (e.g., measured heart rate) that are communicated to the computer store 216 and/or the readmission risk score manager 220. As mentioned, caregiver devices 210 are devices used by clinicians caring for the patient during the patient's stay at the IRF. Clinicians, in turn, may comprise, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, students, office assistants and the like.

The healthcare data elements 224 may comprise, in exemplary aspects, medication information, vital sign information, demographic information, laboratory and/or procedure values, and assessment information for the patient and other patients being cared for at the IRF. More detail regarding the healthcare data elements 224 will be provided below.

The readmission risk score manager 220 is comprised of subcomponents including receiving component 226, accessing component 228, readmission risk score generator 230, categorizing component 232, clinician interface 234, and EHR modifier 236. It will be appreciated that some or all of the subcomponents of the readmission risk score manager 220 may be accessed via the network 218 and may reside on or more devices remote to the consumer device 212, the caregiver device 210, and/or the medical device 214. The readmission risk score manager 220 can perform readmission risk surveillance on some or all of the patients admitted to an IRF and is in communication with the computer store 216, the caregiver device 210, the consumer device 212, the medical device 214, and the electronic health record 222 via the network 218.

The receiving component 226 is in communication with at least the caregiver device 210. In aspects, the caregiver device 210 is configured to communicate a signal to the receiving component 226 where the signal comprises an indication that a patient has been admitted to the IRF. This communication may occur simultaneously with the caregiver device 210 documenting that the patient has been admitted.

The receiving component 226 is further configured to receive contextual data elements regarding the patient while the patient is admitted to the IRF. For instance, the receiving component 226 is configured to receive contextual data elements 225 from the caregiver device 210 where the contextual data elements 225 comprise at least a Rehabilitation Impairment Category (RIC) for the patient, a CMG indication for the patient, co-morbidity information for the patient, and the like. The RIC comprises a primary diagnosis or reason (as indicated by, for example, an ICD9 code) as to why the patient has been admitted to the IRF. The CMG indication indicates a group to which the patient has been classified where the group comprises other patients who share similar characteristics with the patient. The CMG indication may be used as a basis for payment by a payer. Co-morbidity information indicates whether the patient currently has two or more chronic conditions. The RIC, the CMG indication, and the co-morbidity information are typically not available until after the patient has been at the IRF for a certain period of time. In an exemplary aspect, the period of time may comprise approximately four days.

The accessing component 228 is configured to access the computer store 216 on a predetermined schedule to sample a pre-selected set of healthcare data elements 224 for the patient. In exemplary aspects, the accessing component 228 begins sampling on the predetermined schedule subsequent to the receiving component 226 receiving the signal from the caregiver device 210 indicating that the patient has been admitted to the IRF. For instance, the accessing component 228 may begin accessing the computer store 216 within at least 24 hours of the patient being admitted to the IRF. Sampling schedules may vary but, in exemplary aspects, may comprise continuously, every 10 minutes, every 30 minutes, every hour, every couple of hours, once daily, and the like, although sampling schedules outside these values or between these values are contemplated herein.

The pre-selected set of healthcare data elements 224 may comprise medication data elements, laboratory data elements, demographic data elements, assessment data elements, vital sign data elements, and the like. Data elements are included within the pre-selected set if they are found to have statistical significance (P<0.05) in predicting the probability of readmission to an ACF. Medication data elements may comprise medications that the patient is taking while admitted to the IRF and may include oral medications as well as intra-venous (IV) medications. In exemplary aspects, the medication data elements in the pre-selected may comprise any IV medication, albuterol, furosemide, amiodarone, ondansetron, sodium chloride, hydralazine, and clopidogrel.

The laboratory data elements may comprise lab values obtained for the patient while staying at the IRF. In exemplary aspects, the laboratory data elements in the pre-selected set comprise chloride levels, creatinine levels, white blood cell counts, neutrophil counts, glucose values, troponin values, and prothrombin times.

The demographic data elements in the pre-selected set may comprise gender information, and whether the patient is black, Hispanic, or other race. Vital sign data elements in the pre-selected set comprise the most recent abnormal temperature reading, abnormal blood pressure reading, abnormal pulse reading, abnormal oxygen level (pO₂), abnormal respiratory rate, oxygen flow rate via, for example, nasal cannula, and the last time the patient has used his/her patient controlled analgesia (PCA) pump.

Assessment data elements in the pre-selected set may comprise whether medication reconciliation was performed on admission to the IRF, the patient's appetite level upon admission and whether that has changed, an assessment of any pressure ulcers the patient may have on admission as indicated by a Braden score and whether there has been a change in the Braden score, weight on admission to the IRF and whether there has been a weight change, and whether the patient has refused therapy.

The number of healthcare data elements 224 included in the pre-selected set may be variable. For instance, the pre-selected set described above comprises approximately 35 data elements. However, the pre-selected set may comprise up to 50 data elements where each data element has been shown to have statistical significance in predicting the patient's risk of readmission to an ACF. Any and all aspects, and any variation thereof, are contemplated as being within the scope herein.

Once the computer store 216 has been accessed via the accessing component 228 and the pre-selected set of healthcare data elements has been sampled, the readmission risk score generator 230 executes a logistic regression algorithm on the pre-selected set of healthcare data elements to generate a readmission risk score for the patient. In exemplary aspects, prior to executing the logistic regression algorithm, the readmission risk score generator 230 is configured to assign a weight to each data element within the pre-selected set that reflects its importance to the risk of readmission to an ACF. For example, an abnormal respiratory rate may be weighted more heavily than the patient's gender. The outputted readmission risk score comprises a number between 0 and 1 and indicates the probability of the patient being readmitted to an ACF. For instance, a readmission risk score of 0 indicates a low or zero probability of being readmitted to an ACF, while a readmission risk score of 1 indicates a high probability of being readmitted to an ACF.

The categorizing component 232 is configured to utilize the readmission risk score generated for the patient and categorize the patient into one of a high probability risk category, a moderate probability risk category, or a low probability risk category. For instance, a patient having a readmission risk score between 0 and 0.3 may be categorized in the low probability risk category, a patient having a readmission risk score between 0.3 and 0.6 may be categorized in the moderate probability risk category, and a patient have a readmission risk score between 0.6 and 1.0 may be categorized in the high probability risk category. These ranges are exemplary only and it is contemplated that the stratification scheme may be based on other ranges.

In an additional exemplary aspect, the categorizing component 232 is further configured to modify the assigned risk category based on, for example, the patient's Risk Impairment Category (RIC) comprising the patient's primary diagnosis as indicated by, for example, an ICD9 code, the patient's CMG indication, and the patient's co-morbidity information received by the receiving component 226. As mentioned earlier, this information may not be received by the receiving component 226 until several days after the patient has been admitted to the IRF and until after an initial readmission risk score has been generated for the patient.

In an exemplary aspect, ICD9 codes may be limited to codes that have been found to be statistically significant (P<0.05) in predicting the probability of readmission to an ACF. In exemplary aspects, the ICD9 codes may be limited to codes indicating nervous disorders, cerebrovascular disease, breast resection, heart disease, abdominal hernia, liver disease, primary cancer, arthritis osteomyelitis, and gastrointestinal disorders. This is an exemplary list only, and it is contemplated herein that other ICD9 codes may be included in the pre-selected set.

In an exemplary aspect, the CMG indications may be limited to indications that have been found to be statistically significant (P<0.05) in predicting the risk of readmission to an ACF. For instance, the CMG indications may be limited to CMG indications indicating: 1) major multiple trauma with brain or spinal cord injury with motor deficits; 2) traumatic brain injury with motor deficits; 3) stroke with motor deficits; 4) rheumatoid or other arthritis with motor deficits; and 5) miscellaneous with motor deficits (CMG 1803, 0203, 0103, 1302, and 2001 respectively). This is an exemplary list only, and it is contemplated herein that other CMG indications codes may be included in the pre-selected set.

Although not shown, it is contemplated herein that the readmission risk score manager 220 is further configured to use the patient's readmission risk score and/or risk stratification to automatically and without human intervention generate one or more clinical recommendations to reduce the patient's risk for readmission to an ACF.

The clinician interface component 234 is configured to represent the outputs of the readmission risk score manager 220 with visually perceptible elements and to communicate the visually perceptible elements to a browser window of, for example, the caregiver device 210 such that the visually perceptible elements are displayed to an end user such as a clinician caring for the patient. More particularly, the patient's readmission risk score may be represented by a first visually perceptible element, the patient's risk stratification may be represented by a second visually perceptible element, and any clinical recommendations may be represented by a third visually perceptible element.

The EHR modifier component 236 is configured to access the patient's electronic health record (EHR) 222 and modify the patient's EHR to reflect, for example, the patient's readmission risk score 238, the patient's readmission risk category 240, and/or any clinical recommendations generated for the patient based on the risk score 238 and the readmission risk category 240. Modifying the patient's EHR 222 may comprise, for instance, modifying an existing data element within the EHR 222, adding a new date element to the EHR 222, and/or overwriting an existing data element with a new data element. Any and all aspects, and any variation thereof, are contemplated as being within the scope herein. By modifying the patient's EHR 222 to reflect at least the patient's readmission risk score 238 and the patient's readmission risk category 240, subsequent computer users accessing the patient's EHR 222 can quickly retrieve these data elements. This, in turn, reduces the users' navigational burdens associated with accessing and compiling information in an attempt to determine whether the patient is at risk for readmission to an ACF. By reducing navigation burdens (e.g., user clicks or entries), computer processing speeds are improved, power consumption is decreased, and memory usage is decreased.

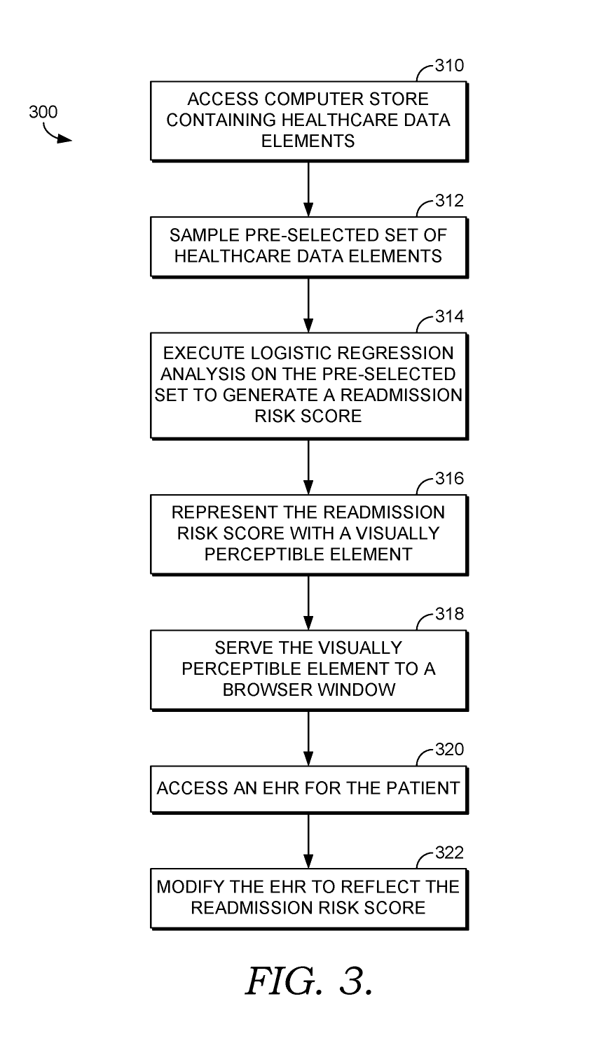

Turning now to FIG. 3, a flow diagram is depicted of an exemplary method 300 of serving a readmission risk score to a clinician of a patient admitted to an inpatient rehabilitation facility. The method 300 is directly related to the computing system architecture 200 described with respect to FIG. 2.

At a step 310, a computer store associated with the IRF is accessed on a predetermined schedule by a server, where the computer store comprises healthcare data elements for the patients being cared for at the IRF. At a step 312, a pre-selected set of the healthcare data elements for the patient is sampled. The pre-selected set may be selected from the patient's medication information, demographic information, laboratory information, assessment information, and vital sign information.

At a step 314, the server executes logistic regression analysis on the pre-selected set of healthcare data elements to generate a readmission risk score for the patient, where the readmission risk score represents a probability of the patient being readmitted to an ACF. In exemplary aspects, the logistic regression analysis may be executed after weights have been assigned to the data elements within the pre-selected set. At a step 316, the readmission risk score is represented by a visually perceptible element, and, at a step 318, the visually perceptible element is served to a browser window where it is displayed. At a step 320, the patient's EHR is accessed, and, at a step 322, the patient's EHR is modified to reflect the patient's readmission risk score.

The method 300 may further comprise using the patient's readmission risk score to assign the patient to one of a high risk of readmission category, a moderate risk of readmission category, and a low risk of readmission category. The patient's EHR may be further modified to reflect the patient's risk category assignment. Additionally, the patient's risk category assignment may be represented by a second visually perceptible element which is served to the browser window such that it can be displayed.

Continuing, the method 300 may further comprise receiving a signal from, for instance, a caregiver device associated with the IRF, where the signal comprises an indication of the patient's RIC, the patient's CMG indication, and the patient's co-morbidities. This information may be received subsequent to the readmission risk score being generated and may be used to modify the patient's readmission risk score and/or assignment to a particular risk category.

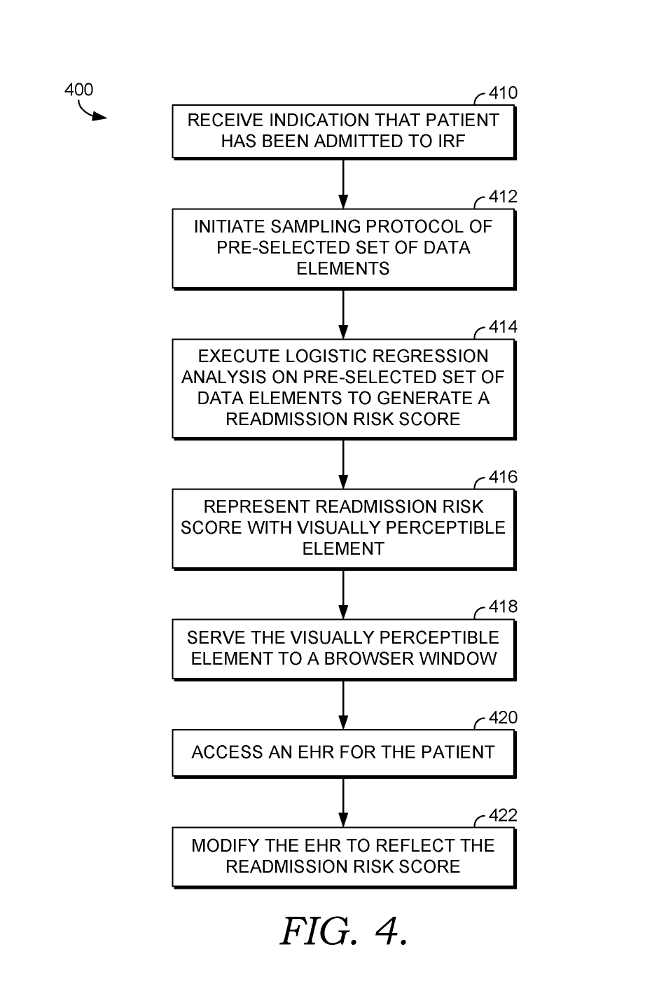

FIG. 4 depicts a flow diagram of an exemplary method 400 of serving a readmission risk score to a clinician of a patient admitted to an inpatient rehabilitation facility. The method 400 is directly related to the computing system architecture 200 described with respect to FIG. 2.

At a step 410 an indication is received from a caregiver device that the patient has been admitted to the IRF. Subsequent to receiving the indication, at a step 412, a sampling protocol is initiated where a computer store associated with the IRF is accessed on a predetermined schedule to sample a pre-selected set of healthcare data elements for the patient. At a step 414, logistic regression is performed on the pre-selected set of healthcare data elements to generate a readmission risk score for the patient. At a step 416, the readmission risk score is represented with a visually perceptible element that is served to a browser window at a step 418 where it is displayed. At a step 420, the patient's EHR is accessed, and, at a step 422, the EHR is automatically modified to reflect the patient's readmission risk score.

The method 400 may further comprise using the patient's readmission risk score to automatically and without human intervention generate a clinical recommendation for the patient. The clinical recommendation may be associated with a visually perceptible element and served to a browser window where it is displayed. As well, the patient's EHR may be automatically modified to reflect the clinical recommendation.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. A system useful in a computer healthcare system serving a readmission risk score for a patient admitted to an inpatient rehabilitation facility, the system comprising:
a computer store containing healthcare data elements for the patient; and
a computer server at the computer healthcare system, the computer server coupled to the computer store and programmed to:
automatically access the computer store on a predetermined schedule to sample a pre-selected set of the healthcare data elements;
automatically execute logistic regression analysis on the pre-selected set of the healthcare data elements to generate a readmission risk score for the patient;
represent the readmission risk score with a visually perceptible element;
serve the visually perceptible element representing the readmission risk score to a browser window that displays the visually perceptible element;
automatically access an electronic health record for the patient; and
automatically modify the electronic health record for the patient to reflect the readmission risk score.

2. The system of claim 1, wherein the computer store is associated with the inpatient rehabilitation facility.

3. The system of claim 1, wherein the computer server automatically begins accessing the computer store on the predetermined schedule incident to receiving an indication that the patient has been admitted to the inpatient rehabilitation facility.

4. The system of claim 1, wherein the readmission risk score comprises a probability that the patient will be readmitted to an acute care facility.

5. The system of claim 4, further comprising automatically assigning the patient into one of a high probability category, a moderate probability category, or a low probability category based on the patient's readmission risk score.

6. The system of claim 5, representing the assignment of the patient to a probability category by a second visually perceptible element, and serving the second visually perceptible element to the browser window such that the second visually perceptible element is displayed.

7. The system of claim 1, wherein the pre-selected set of healthcare data elements comprises one or more of medications taken by the patient, vital signs associated with the patient, laboratory values associated with the patient, the patient's demographic information, and the patient's assessment information.

8. The system of claim 7, wherein healthcare data elements within the pre-selected set of healthcare data elements are pre-assigned different weights.

9. One or more computer-storage media having computer-usable instructions that, when used by one or more computing devices, cause the one or more computing devices to perform a method for serving a readmission risk score to a clinician of a patient admitted to an inpatient rehabilitation facility, the method comprising:
automatically accessing a computer store containing healthcare data elements for the patient;
automatically sampling a pre-selected set of the healthcare data elements;
automatically executing logistic regression analysis on the pre-selected set of the healthcare data elements to generate a readmission risk score for the patient;
representing the readmission risk score with a visually perceptible element;
serving the visually perceptible element representing the readmission risk score to a browser window that displays the visually perceptible element;
automatically accessing an electronic health record for the patient; and
automatically modifying the electronic health record for the patient to reflect the readmission risk score.

10. The media of claim 9, further comprising automatically generating a first assignment of the patient into one of a high probability category, a moderate probability category, or a low probability category based on the patient's readmission risk score.

11. The media of claim 10, further comprising automatically modifying the electronic health record for the patient to reflect the first assignment.

12. The media of claim 10, further comprising:
representing the first assignment with a second visually perceptible element; and
serving the second visually perceptible element representing the first assignment to the browser window such that the second visually perceptible element is displayed.

13. The media of claim 10, further comprising:
receiving a signal from a user device, wherein the signal comprises an indication of the patient's RIC score, Case Mixed Group (CMG), and co-morbidities; and
automatically generating a second assignment of the patient into one of the high probability category, a moderate probability category, or a low probability category based on the patient's RIC score, CMG, and co-morbidities.

14. The media of claim 13, wherein the signal from the user device is received subsequent to generating the readmission risk score for the patient.

15. A computerized method carried out by a server for serving a readmission risk score to a clinician of a patient admitted to an inpatient rehabilitation facility, the method comprising:
receiving an indication that the patient has been admitted to the inpatient rehabilitation facility;
incident to receiving the indication that the patient has been admitted to the inpatient rehabilitation facility, automatically initiating a sampling protocol wherein a computer store associated with the inpatient rehabilitation facility is accessed on a predetermined schedule to sample a pre-selected set of healthcare data elements associated with the patient;
automatically executing logistic regression analysis on the pre-selected set of healthcare data elements to generate a readmission risk score for the patient;
representing the readmission risk score with a visually perceptible element;
serving the visually perceptible element representing the readmission risk score to a browser window that displays the visually perceptible element;
accessing an electronic health record of the patient; and
modifying the electronic health record to reflect the readmission risk score for the patient.

16. The method of claim 15, wherein the readmission risk score comprises a probability that the patient will be re-admitted to an acute care facility.

17. The method of claim 15, wherein each data element within the pre-selected set of data elements is weighted.

18. The method of claim 15, further comprising:
automatically generating a clinical recommendation for the patient based on the patient's readmission risk score; and
modifying the electronic health record to reflect the clinical recommendation.

19. The method of claim 18, further comprising:
representing the clinical recommendation with a second visually perceptible element; and
serving the second visually perceptible element representing the clinical recommendation to the browser window such that the second visually perceptible element is displayed.

20. The method of claim 15, further comprising automatically categorizing the patient into one of a high probability category, a moderate probability category, or a low probability category based on the patient's readmission risk score.
